(19) United States
(12) Patent Application Publication
(10) Pub. No.: US 2022/0017750 A1
(43) Pub. Date: Jan. 20, 2022

(54) BITUMINOUS MASTIC, METHOD FOR PREPARING SAME AND USES THEREOF

(71) Applicant: TOTAL MARKETING SERVICES, Puteaux (FR)

(72) Inventors: Laurence LAPALU, Villeurbanne (FR); Pauline ANACLET, Oullins (FR); Olivier GAMET, Bailly Romainvilliers (FR)

(73) Assignee: TOTAL MARKETING SERVICES, Puteaux (FR)

(21) Appl. No.: 17/311,490

(22) PCT Filed: Dec. 2, 2019
(86) PCT No.: PCT/EP2019/083303

§ 371 Date: Jun. 7, 2021

(30) Foreign Application Priority Data
Dec. 5, 2018 (FR) FR1872400

(51) Int. Cl. C08L 95/00; E01C 7/18; E01C 7/22; E01C 7/26

(52) U.S. Cl. CPC C08L 95/00; E01C 7/187; E04B 1/6801; E01C 7/265; E01C 7/22

(57) ABSTRACT

A bituminous mastic includes:—from 0.5% to 25% by mass of at least one hydrocarbon oil, the total content of paraffinic compounds of which, measured according to the ASTM d2140 method, is greater than or equal to 50% by mass, and preferably greater than or equal to 60% by mass, relative to the total mass of the oil,—from 15% to 60% by mass of bitumen,—from 20% to 60% by mass of fillers, and—at most 14%, by mass of at least one polymer, preferably chosen from elastomers, relative to the total mass of bituminous mastic. A method for preparing such a bituminous mastic and to the uses thereof, in particular in certain road and/or industrial applications.

### TECHNICAL FIELD

The present invention relates to a bituminous mastic comprising, on the one hand, a mixture of at least one bitumen-based hydrocarbon binder and at least one hydrocarbon oil, and, on the other hand, fines. The invention also relates to a method for preparing said bituminous mastic and uses thereof, notably for certain road and/or industrial applications.

### PRIOR ART

It is common in the field of construction, notably in building construction or road applications, to observe the presence of discontinuities, notably cracks, on the surface of materials. Often already present in the initial structure, the dimensions of these discontinuities change over time. The expansion of these discontinuities leads to problems of structural integrity but also, when present on the outer surface of the material, to the introduction of water in the material. Most of the materials traditionally used in the field of construction are affected by these phenomena, including wood, brick, concrete and metal, but also asphalt for pavement construction.

There are a number of phenomena that influence changes in these discontinuities. By way of example, mention may be made of the climatic conditions that influence notably the temperature and humidity of the materials. Changes in these parameters result, for the material, in the appearance of successive contraction and expansion phases which favor the propagation, notably the widening and/or elongation, of these discontinuities. A sudden variation of these conditions, notably in the form of thermal shock, can thus lead to a rapid and sudden change in the size of the discontinuities.

With regard to road applications, it is also necessary to mention the stresses related to vehicular traffic on the pavement, such as permanent deformation (rutting and/or indentation) and/or shrinkage of the underlying layers, which accelerate the deterioration of the pavement and the propagation of these discontinuities.

Furthermore, each material has its own expansion/contraction rate which changes over time independently of the others. Moreover, the different deformations undergone by the material can compensate each other or, conversely, accumulate. Overall structural behavior is therefore very difficult to predict.

It is essential to limit the propagation of these discontinuities, notably cracks, in order to preserve the integrity of the structure but also to protect the structure from the possible introduction of water.

In order to prevent changes in these discontinuities, it is common practice in the building and road application field to repair, seal or fill these discontinuities with a bituminous mastic that is able to absorb the stresses that may occur in one of the elements of the structure without transmitting them to the rest of the structure.

It is also common to use these same bituminous mastics to bridge joints between separate elements of a structure. For example, these bituminous mastics can be used to form a joint between two poured cement concrete slabs, notably during road construction.

In both cases, the problems are the same. It is a matter of providing a material that is resistant to cracking and capable of filling the space left between the two elements while allowing these two elements to be joined together in the more or less long term.

WO 94/14896 A1 teaches the preparation of bitumen/polymer compositions from crosslinked rubber particles, notably derived from recycled car tires.

EP 0 782 977 A1 discloses compositions that can be used as a sealant coating. These compositions consist, on the one hand, of an aqueous latex and, on the other hand, of a carrier oil in which a vulcanizing agent and a hygroscopic agent are dispersed.

FR 2 897 359 A1 discloses a bituminous mastic comprising, on the one hand, a bitumen-based hydrocarbon binder and, on the other hand, fines, part of which are ultrafines. However, this document does not relate to the treatment of cracks but the provision of a master batch that can be used for the preparation of bituminous materials such as mastic asphalt or bituminous mixes. Neither does this document teach the preparation of bituminous mastic from a hydrocarbon oil of petroleum origin.

FR 2 968 655 A1 discloses a clear, colorable mastic based on a synthetic or natural oil, a resin and an elastomer. This document does not teach the preparation of a mastic from a bituminous material.

FR 3 034 773 A1 discloses a clear binder composition based on a synthetic oil with a high content of paraffinic compounds and a copolymer based on conjugated diene units and monovinyl aromatic hydrocarbon units. However, this document does not disclose the preparation of a bituminous mastic and does not relate to the treatment of cracks.

However, there is still a need to provide bituminous mastic compositions with:
a more suitable plasticity index, i.e., on the one hand, a low point of weakness (Fraass), and, on the other hand, a high penetrability at 25° C. and a high softening point (ring-and-ball temperature),
low viscosity,
good creep resistance,
good rutting resistance, and
good cracking resistance.

The Applicant has surprisingly established that the judicious choice of a synthetic oil with a high paraffinic content makes it possible to obtain a bituminous mastic with improved mechanical properties.

### SUMMARY OF THE INVENTION

The invention relates to a bituminous mastic comprising:
from 0.5% to 25% by mass of at least one hydrocarbon oil whose total content of paraffinic compounds, measured according to the ASTM D2140 method, is greater than or equal to 50% by mass, preferably greater than or equal to 60% by mass, based on the total mass of the oil,
from 15% to 60% by mass of bitumen,
from 20% to 60% by mass of fillers, and
at most 14% by mass of at least one polymer, preferably selected from elastomers, based on the total mass of bituminous mastic.

The invention also relates to a method for preparing a bituminous mastic as defined above and in detail below, comprising at least the following steps:
(1) heating the bitumen to a temperature ranging from 100° C. to 220° C., preferably from 130° C. to 190° C., more advantageously from 140° C. to 180° C.,
(2) introducing the hydrocarbon oil with stirring,
(3) optionally adding the polymer,
(4) introducing the fillers, and
(5) mixing the mixture.

According to a preferred embodiment, the hydrocarbon oil is selected from synthetic oils derived from deasphalting unit fractions (DAO) and mixtures thereof.

According to a preferred embodiment, the hydrocarbon oil has a content of naphthenic compounds, measured according to the ASTM D2140 standard, of less than or equal to 25% by mass, preferably ranging from 5% to 25% by mass, more preferentially ranging from 10 to 25% by mass, based on the total mass of hydrocarbon oil.

According to a preferred embodiment, the hydrocarbon oil has a content of paraffinic compounds, measured according to the ASTM D2140 standard, greater than or equal to 50% by mass, preferably greater than or equal to 60% by mass, based on the mass of hydrocarbon oil.

According to a preferred embodiment, the hydrocarbon oil has an aniline point, determined according to the ISO 2977:1997 standard, greater than or equal to 80° C., preferably greater than or equal to 90° C., more preferentially greater than or equal to 100° C.

According to a preferred embodiment, the polymer is selected from block copolymers, preferably based on conjugated diene units and monovinyl aromatic hydrocarbon units, advantageously based on butadiene units and styrene units.

According to a preferred embodiment, the polymer is selected from styrene-butadiene block copolymers having a weight content of 1,2-vinyl groups ranging from 10% to 70%, preferably from 10% to 50%, more preferentially from 15% to 40%, and advantageously from 10% to 40%, even more preferentially from 20% to 40% by mass, based on the total mass of the copolymer.

According to a preferred embodiment, the block copolymer based on styrene and butadiene has a mass-average molecular mass ranging from 10 000 to 500 000 g·mol⁻¹, preferably ranging from 50 000 to 200 000 g·mol⁻¹, more preferentially ranging from 50 000 to 150 000 g·mol⁻¹.

The invention further relates to the use of a bituminous mastic as defined above and in detail below for sealing and/or repairing cracks present on the surface of a building material.

According to a preferred embodiment of the use, the cracks are present on the surface of a structure, a building or a roadway, preferably a roadway.

The invention also relates to the use of a bituminous mastic as defined above and in detail below as a joint between two structural elements of a construction.

The invention also relates to the use of a bituminous mastic as defined above and in detail below to limit and/or prevent and/or delay the propagation, notably the elongation and/or widening, of discontinuities, notably cracks, present on the surface of a structure, a building or a roadway.

The invention also relates to the use of a bituminous mastic as defined above and in detail below to limit and/or prevent and/or delay the penetration and/or introduction of water into a structure, a building or a roadway.

The invention further relates to a method for sealing and/or plugging and/or repairing a crack present on the surface of a structure, a building or a roadway, this method comprising:
(1) providing a bituminous mastic as defined above and in detail below, said bituminous mastic being conditioned at a temperature ranging from 100° C. to 200° C., preferably ranging from 120° C. to 180° C., more preferentially ranging from 130° C. to 160° C.,
(2) introducing said heated bituminous mastic into the crack, and
(3) cooling the bituminous mastic.

The invention further relates to a method for maintaining and/or enhancing the waterproofing of a structure, this method comprising:
(1) providing a bituminous mastic as defined above and in detail below, said bituminous mastic being conditioned at a temperature ranging from 100° C. to 200° C., preferably ranging from 120° C. to 180° C., more preferentially ranging from 130° C. to 160° C.,
(2) spreading said bituminous mastic over all or part of the surface of the structure, and
(3) cooling the bituminous mastic.

### DETAILED DESCRIPTION

The phrase “consists essentially of” followed by one or more features, means that, in addition to the explicitly listed components or steps, the method or material of the invention may include components or steps that do not significantly alter the properties and features of the invention.

The expression “comprised between X and Y” includes the bounds, unless explicitly stated otherwise. This expression means that the interval in question includes the values X, Y and all values ranging from X to Y.

The invention first relates to a bituminous mastic comprising at least:
a hydrocarbon oil comprising a total content of paraffinic compounds, measured according to the ASTM D2140 method, of at least 50% by mass, preferably of at least 60% by mass, more preferentially ranging from 50% to 90% by mass, and advantageously ranging from 60% to 80% by mass, based on the mass of hydrocarbon oil,
bitumen,
fillers, and
optionally, a polymer, preferably selected from elastomers.

Bituminous mastics are materials intended to repair and/or seal and/or fill discontinuities present on the surface of another material, generally in the field of roads or construction, and to absorb the stresses that may occur inside said material. Mastics are characterized by a high content of fillers, typically greater than or equal to 20% by mass based on the total mass of the composition.

Advantageously, the bituminous mastic according to the invention consists essentially of:
one or more hydrocarbon oils comprising a total content of paraffinic compounds, measured according to the ASTM D2140 method, of at least 50% by mass, preferably of at least 60% by mass, more preferentially ranging from 50% to 90% by mass, and advantageously ranging from 60% to 80% by mass, based on the mass of hydrocarbon oil,
bitumen,
fillers,
optionally, one or more polymers, preferably selected from elastomers,
optionally, one or more crosslinking compounds,
optionally, one or more hydrogen sulfide scavengers, and
optionally, adhesion promoters.

### Hydrocarbon Oil

The bituminous mastic according to the invention comprises at least one hydrocarbon oil.

The hydrocarbon oil present in the bituminous mastic according to the invention acts as a “fluxing agent”. More particularly, the presence of the hydrocarbon oil fluidizes and reduces the viscosity and the modulus of the mastic obtained.

In a preferred embodiment of the invention, the hydrocarbon oil is selected from synthetic oils derived from reduced-pressure distillation deasphalting fractions (vacuum residue, VR) of crude oil (hereinafter referred to as “DAO oil”).

In particular, in a preferred embodiment, the hydrocarbon oil present in the bituminous mastic according to the invention consists essentially of a DAO oil.

The contents of paraffinic, naphthenic and aromatic compounds mentioned in the present application are determined according to the ASTM D2140 standard, in percent by mass based on the weight of the oil.

In a specific embodiment, the hydrocarbon oil present in the bituminous mastic according to the invention, preferably selected from DAO oils, has a total content of paraffinic compounds greater than or equal to 50% by mass, preferably greater than or equal to 60% by mass, preferably ranging from 50% to 90% by mass, more preferentially from 50% to 80% by mass and in particular from 55% to 75% by mass or in particular from 60% to 75% by mass, advantageously from 60% to 70% by mass, based on the total mass of hydrocarbon oil.

In a more specific embodiment of the invention, the hydrocarbon oil, preferably selected from DAO oils, has a total content of naphthenic compounds that is less than or equal to 25% by mass, for example ranging from 5% to 25% by mass, and in particular ranging from 10% to 25% by mass, based on the total mass of hydrocarbon oil.

In a more specific embodiment of the invention, the hydrocarbon oil, preferably selected from DAO oils, further has a total content of aromatic compounds of less than or equal to 25% by mass, for example ranging from 5% to 25% by mass, and in particular ranging from 8% to 18% by mass, based on the total mass of hydrocarbon oil.

In a preferred embodiment of the invention, the hydrocarbon oil, preferably selected from DAO oils, has:
(i) a total content of paraffinic compounds ranging from 50% to 90% by mass;
(ii) a total content of naphthenic compounds ranging from 5% to 25% by mass, preferably ranging from 15% to 25% by mass; and
(iii) a total content of aromatic compounds ranging from 5% to 25% by mass, preferably ranging from 10% to 15% by mass,
based on the total mass of hydrocarbon oil.

In a more preferred embodiment of the invention, the hydrocarbon oil, preferably selected from DAO oils, has:
(i) a total content of paraffinic compounds ranging from 60% to 75% by mass;
(ii) a total content of naphthenic compounds ranging from 5% to 25% by mass, preferably ranging from 15% to 25% by mass; and
(iii) a total content of aromatic compounds ranging from 5% to 25% by mass, preferably ranging from 10% to 15%,
based on the total mass of hydrocarbon oil.

According to an embodiment, the hydrocarbon oil, present in the bituminous mastic according to the invention, has an aniline point, determined according to the ISO 2977:1997 standard, greater than or equal to 80° C., preferably greater than or equal to 90° C., more preferentially greater than or equal to 100° C.

Oils having the above features and usable for the preparation of a bituminous mastic according to the invention can notably be obtained by methods for deasphalting vacuum residues (VR) derived from petroleum refining, for example by deasphalting with a C₃ to C₆ solvent, preferably by deasphalting with propane. These deasphalting methods are well known to a person skilled in the art and are described, for example, in Lee et al. 2014, Fuel Processing Technology 119: 204-210. Residues derived from vacuum distillation (VR) are separated according to their molecular weight in the presence of C₃ to C₆ solvent (for example propane). The resulting oil referred to as DAO (deasphalted oil) is rich in paraffin, has a very low asphaltene content, has an evaporation temperature comprised between 440° C. and 750° C., and has an API gravity much higher than the vacuum residue.

The API (American Petroleum Institute) gravity or API density of an oil can be

$${G}_{API} = \frac{141 , 5}{d} - 131 \text{,} 5 \qquad ( 1 )$$

obtained from the following equation (1):

with:
G_{API}, the API gravity of the oil considered (expressed without units), and
d, the density at 16° C. (60° F.) of the oil considered (expressed without units), taking 10 water as reference.

The respective contents of paraffinic, naphthenic and aromatic compounds depend to some extent on the nature of the crude oil from which the DAO oil originates and the refining process used. A person skilled in the art knows how to determine the respective contents of paraffinic, naphthenic and aromatic compounds in a DAO oil, for example, using the SARA fractionation method also described in Lee et al. 2014, Fuel Processing Technology 119: 204-210, and thus select the appropriate DAO oil for the preparation of the bituminous mastic composition according to the invention.

In a specific embodiment, the amount of hydrocarbon oil present in the bituminous mastic according to the invention ranges from 0.5% to 25% by mass, preferably from 1% to 25% by mass, more preferentially from 1% to 12% by mass, based on the total mass of bituminous mastic.

### Bitumen

In the sense of the invention, “bitumen” means all bituminous compositions consisting of one or more bitumen bases and optionally comprising one or more chemical additives.

Among the bitumen bases that can be used in the bituminous mastics according to the invention, mention may be made first of bitumens of natural origin, those contained in natural bitumen deposits, natural asphalt or oil sands and bitumens originating from the refining of crude oil. The bitumen bases are advantageously selected from the bitumen bases originating from the refining of crude oil. The bitumen bases can be selected from bitumen bases or mixtures of bitumen bases originating from the refining of crude oil, in particular bitumen bases containing asphaltenes or pitches. The bitumen bases can be obtained by conventional methods for manufacturing bitumen bases in refineries, in particular by direct distillation and/or vacuum distillation of oil. These bitumen bases can be optionally visbroken and/or deasphalted and/or air-rectified. It is common to proceed to the vacuum distillation of atmospheric residues originating from the atmospheric distillation of crude oil. This manufacturing method corresponds, therefore, to the succession of an atmospheric distillation and a vacuum distillation, the vacuum distillation feedstock corresponding to the atmospheric residues. These vacuum residues derived from the vacuum distillation tower can also be used as bitumen. It is also common practice to inject air into a feedstock typically consisting of distillates and heavy products originating from the vacuum distillation of atmospheric residues originating from petroleum distillation. This method results in a blown, or semi-blown or oxidized or air-rectified or partially air-rectified base.

The different bitumen bases obtained by the refining methods can be combined to obtain the best technical compromise. The bitumen base can also be a recycled bitumen base. The bitumen bases can be hard or soft grade bitumen bases.

For conventional methods for manufacturing bitumen bases, the manufacturing temperatures used are generally comprised between 100° C. and 200° C., preferably between 140° C. and 200° C., more preferentially between 140° C. and 170° C., and with stirring for a duration of at least 10 minutes, preferably comprised between 30 minutes and 10 hours, more preferentially between 1 hour and 6 hours. Manufacturing temperature is understood to mean the heating temperature of the bitumen base(s) before mixing as well as the mixing temperature. The temperature and duration of heating vary according to the amount of bitumen used and are defined by the NF EN 12594 standard.

Blown bitumens can be made in a blowing unit by passing a stream of air and/or oxygen through a starting bituminous base. This operation can be carried out in the presence of an oxidation catalyst, such as phosphoric acid. Generally, the blowing is carried out at high temperatures, of the order of 200 to 300° C., for relatively long durations, typically between 30 minutes and 2 hours, continuously or in batches. The blowing duration and temperature are adjusted according to the intended properties of the blown bitumen and according to the quality of the starting bitumen.

Preferentially, the bitumen base has a needle penetration, measured at 25° C. according to the EN 1426 standard, ranging from 5 to 330 1/10 mm, preferably from 20 to 220 1/10 mm.

In a well-known manner, the so-called “needle penetration” measurement is carried out by means of a standardized test NF EN 1426 at 25° C. (P₂₅). This penetrability characteristic is expressed in tenths of a millimeter (dmm or 1/10 mm). The needle penetration, measured at 25° C., according to the standardized test NF EN 1426, represents the measurement of the penetration in a sample of bitumen, after a time of 5 seconds, of a needle whose weight with its support is 100 g. The NF EN 1426 standard replaces the approved NF T 66-004 standard of December 1986 with effect from 20 Dec. 1999 (decision of the Director General of AFNOR dated 20 Nov. 1999).

The amount of bitumen base present in the bituminous mastic according to the invention preferably ranges from 15% to 60% by mass, more preferentially from 20% 20 to 45% by mass, even more preferentially from 25% to 40% by mass, based on the total mass of bituminous mastic.

### Fillers

The fillers present in the bituminous mastic according to the invention consist predominantly of fines. According to a particular embodiment, the fillers further comprise sands.

In the sense of the invention, “fillers” means particles of materials which are inert with respect to each of the constituents of the bituminous mastic according to the invention, notably with respect to the hydrocarbon oil, the bitumen or the polymer optionally present.

These particles of inert materials are used in the bituminous mastic according to the invention as filler material.

The fillers present in the bituminous mastic according to the invention preferably have a diameter less than or equal to 125 μm, preferably less than or equal to 100 μm, even more preferentially less than or equal to 75 μm, advantageously less than or equal to 65 μm. This type of filler is commonly called “fines”.

The fillers present in the bituminous mastic according to the invention are preferably selected from organic fillers, mineral fillers and mixtures thereof, preferably selected from mineral fillers.

As mineral fillers which can be used for the preparation of a bituminous mastic according to the invention, mention may be made notably of: silica fumes; colloidal silicas, in particular combustion silicas and precipitation silicas; clays, notably phyllosilicates such as bentonites; attapulgite; chlorites; kaolins; talc; chalk; metal oxides such as alumina, rutile, anatase or zinc oxides; metal hydroxides such as aluminum or iron hydroxide; metal nitrides such as boron nitride and mixtures of these materials.

These mineral fillers may optionally have been treated, notably to render at least part of their surface hydrophobic.

The amount of fillers present in the bituminous mastic according to the invention preferably ranges from 20% to 60% by mass, more preferentially from 30% to 50% by mass, more preferentially from 40% to 50% by mass, based on the total mass of the bituminous mastic.

According to a particular embodiment, when sand is used as a filler in the composition according to the invention, sands with a diameter of less than 2 mm, preferably with a diameter ranging from 50 μm to 2 mm, are advantageously selected.

When the bituminous mastic according to the invention is intended to seal and/or repair cracks, sands with a diameter of less than or equal to 0.5 mm are preferably selected.

A fine particle size of the fillers, and notably of the sand, allows the bituminous mastic to penetrate and fill the heart of the cracks whose width is very small.

If the mastic is used as a sealant or as a waterproofing layer, the sands can have a higher particle size.

The selection of the optimal particle size is adapted by a person skilled in the art according to the application.

Preferably, the sands are selected from semi-crushed or rolled sands.

Preferably, the fines represent at least 60% by mass of the fillers present in the bituminous mastic according to the invention, more preferentially at least 80% by mass, even more preferentially at least 90% by mass, and advantageously at least 95% by mass, based on the total mass of the fillers present in the bituminous mastic.

Advantageously, the fillers consist essentially of fines.

### Polymer

According to an embodiment, the bituminous mastic according to the invention further comprises at least one polymer, preferably selected from elastomers.

The polymer is preferably selected from block copolymers, more preferentially selected from block copolymers based on conjugated diene units and monovinyl aromatic hydrocarbon units.

The conjugated diene is preferably selected from those having from 4 to 8 carbon atoms per monomer, for example from butadiene, 2-methyl-1,3-butadiene (isoprene), 2,3-dimethyl-1,3-butadiene, 1,3-pentadiene and 1,2-hexadiene, chloroprene, carboxylated butadiene, carboxylated isoprene, in particular from butadiene, isoprene, and mixtures thereof.

The monovinyl aromatic hydrocarbon is preferably selected from styrene, o-methyl styrene, p-methyl styrene, p-tert-butylstyrene, 2,3-dimethyl-styrene, vinyl naphthalene, vinyl toluene, vinyl xylene, and the like or mixtures thereof, in particular styrene.

More preferentially, the polymer consists of one or more block copolymers selected from styrene-butadiene, styrene-isoprene, styrene-chloroprene, carboxylated styrene-butadiene or carboxylated styrene-isoprene copolymers. A preferred block copolymer is a copolymer based on butadiene units and styrene units such as the styrene-butadiene SB block copolymer or the styrene-butadiene-styrene SBS block copolymer.

The styrene-conjugated diene block copolymer, in particular the styrene-butadiene block copolymer, advantageously has a styrene content by weight ranging from 5% to 50%, preferably from 20% to 50%, based on the total mass of the copolymer.

The styrene-conjugated diene block copolymer, in particular the styrene-butadiene block copolymer, advantageously has a (1,2- and 1,4-)butadiene content by weight ranging from 50% to 95%, based on the total mass of the copolymer.

The styrene-conjugated diene block copolymer, in particular the styrene-butadiene block copolymer, advantageously has a 1,2 vinyl group content by weight ranging from 10% to 70%, preferably from 10% to 50%, more preferentially from 10% to 40%, even more preferentially from 15% to 40%, advantageously from 20% to 40%, based on the total mass of the copolymer. The 1,2 vinyl units are the units which result from the polymerization via the 1,2 addition of the butadiene units.

The mass-average molecular mass of the styrene-conjugated diene block copolymer, and notably that of the styrene-butadiene copolymer, may be comprised, for example, between 10 000 and 500 000, preferably 50 000 and 200 000 and more preferentially from 50 000 to 150 000 daltons.

In a specific embodiment, the total amount of polymer in the bituminous mastic according to the invention is less than or equal to 14% by mass, preferably ranges from 1% to 12% by mass, more preferentially from 2% to 9% by mass, advantageously from 3% to 7% by mass, advantageously from 4% to 6% by mass, based on the total mass of the bituminous mastic.

When the bituminous mastic according to the invention comprises at least one polymer, it may optionally also comprise at least one crosslinking compound capable of reacting with said polymer.

Preferably, according to this optional alternative, the polymer is selected from elastomers and/or plastomers that may be functionalized and/or may have reactive sites.

Preferably, the crosslinking compound is selected from vulcanizing agents and crosslinking agents.

Among the vulcanizing agents, mention may be made of vulcanizing agents based on sulfur and derivatives thereof. The vulcanizing agents are generally introduced into the bituminous mastic according to the invention in a content ranging from 0.01% to 30% by mass based on the mass of elastomer.

Among the crosslinking agents, mention may be made of cationic crosslinking agents such as mono- or polyacids; carboxylic anhydrides; carboxylic acid esters; sulfonic, sulfuric or phosphoric acids; acid chlorides; phenols and mixtures thereof. The crosslinking agents are capable of reacting with the elastomer and/or the functionalized plastomer. They can be used in addition to or instead of the vulcanizing agents defined above. The crosslinking agents are generally introduced into the bituminous mastic according to the invention in a content ranging from 0.01% to 30% by mass based on the mass of polymer.

Furthermore, when the bituminous mastic according to the invention comprises at least one vulcanizing agent based on sulfur, it may further comprise at least one hydrogen sulfide scavenger.

### Hydrogen Sulfide (H₂S) Scavengers

According to an embodiment, the mastic composition according to the invention further comprises at least one hydrogen sulfide (H₂S) scavenger.

As hydrogen sulfide scavengers, mention may be made, by way of example, of metal, organic or inorganic salts, notably selected from zinc, cadmium, mercury, copper, silver, nickel, platinum, iron, magnesium salts or mixtures thereof. Preferably, the metal, organic or inorganic salts are selected from zinc and/or copper salts.

Examples of hydrogen sulfide scavengers are notably described in WO 2005/065177 and WO 2015/071154.

Preferably, according to this embodiment, the bituminous mastic according to the invention comprises from 0.01% to 5% by mass of one or more hydrogen sulfide scavengers, more preferentially from 0.05% to 3% by mass, even more preferentially from 0.1% to 1% by mass, the percentages being expressed in relation to the total mass of the bituminous mastic.

### Adhesion Promoters

In order to improve the mutual affinity between the binder consisting of bitumen and hydrocarbon oil and the fillers and to ensure its durability, adhesion promoters can also be added to the mastic according to the invention. These are, for example, nitrogenous surfactant compounds derived from fatty acids (amines, polyamines, alkyl polyamines, etc.).

When added to the bituminous mastic, the adhesion promoters preferably represent from 0.05% to 1% by weight based on the weight of the bituminous mastic. For example, in one specific embodiment, from 0.05% to 0.5% by mass of adhesion promoters, preferably from 0.1% to 0.3% by mass of adhesion promoters, are added.

### Bituminous Mastic

Preferably, the bituminous mastic according to the invention comprises, preferably consists essentially of:
from 0.5% to 25% by mass of one or more hydrocarbon oils,
from 15% to 60% by mass of bitumen,
from 20% to 60% by mass of fillers,
at most 14% by mass of one or more polymers,
optionally, from 0.01% to 30% by mass of one or more crosslinking compounds,
optionally, from 0.01% to 5% by mass of one or more hydrogen sulfide scavengers, and
optionally, from 0.05% to 1% by mass of adhesion promoters,
based on the total mass of the bituminous mastic.

More preferentially, the bituminous mastic according to the invention comprises, preferably consists essentially of:
from 1% to 25% by mass of one or more hydrocarbon oils,
from 20% to 45% by mass of bitumen,
from 30% to 50% by mass of fillers,
optionally, from 1% to 12% by mass of one or more polymers,
optionally, from 0.01% to 30% by mass of one or more crosslinking compounds,
optionally, from 0.05% to 3% by mass of one or more hydrogen sulfide scavengers, and
optionally, from 0.05% to 1° A by mass of adhesion promoters,
based on the total mass of the bituminous mastic.

Even more preferentially, the bituminous mastic according to the invention comprises, preferably consists essentially of:
from 1% to 25% by mass of one or more hydrocarbon oils,
from 25% to 40% by mass of bitumen,
from 40% to 50% by mass of fillers, and
optionally, from 2% to 9% by mass of one or more polymers, more preferentially from 3% to 7% by mass, even more preferentially from 4% to 6% by mass,
optionally, from 0.01% to 30% by mass of one or more crosslinking compounds,
optionally, from 0.1% to 1% by mass of one or more hydrogen sulfide scavengers, and
optionally, from 0.05% to 1% by mass of adhesion promoters,
based on the total mass of the bituminous mastic.

The bituminous mastic according to the invention preferably has a dynamic viscosity at 160° C., determined according to the NF EN 13702 standard, ranging from 200 to 1000 mPa·s, more preferentially from 200 to 600 mPa·s, even more preferentially from 200 to 500 mPa·s, advantageously from 250 to 350 mPa·s.

Preferably, the bituminous mastic according to the invention has a dynamic viscosity, determined according to the NF EN 13702 standard, of 150 to 400 mPa·s, more preferentially of 200 to 350 mPa·s.

The bituminous mastic according to the invention preferably has a Fraass point of weakness, determined according to the EN 12593 standard, of less than or equal to −15° C., more preferentially less than or equal to −20° C., even more preferentially less than or equal to −30° C.

The bituminous mastic according to the invention preferably has a penetrability at 25° C., determined according to the EN 1426 standard, greater than or equal to 150 1/10 mm, more preferentially greater than or equal to 155 1/10 mm, even more preferentially greater than or equal to 160 1/10 mm.

The bituminous mastic according to the invention preferably has a ring-and-ball softening temperature or RBT, measured according to the EN 1427 standard, greater than or equal to 60° C., more preferentially greater than or equal to 65° C., even more preferentially greater than or equal to 70° C., advantageously greater than or equal to 75° C., more advantageously greater than or equal to 80° C.

### Method for Preparing the Bituminous Mastic

The present invention also relates to a method for preparing a bituminous mastic as defined above. Preferably, the preparation method according to the invention comprises at least the following steps:
(1) heating the bitumen, preferably with stirring, to a temperature ranging from 100° C. to 220° C., preferably from 130° C. to 190° C., more advantageously from 140° C. to 180° C.,
(2) introducing the hydrocarbon oil(s), preferably with stirring,
(3) optionally introducing the polymer(s) and even more optionally introducing the crosslinking compound(s) and/or hydrogen sulfide scavenger(s) and/or adhesion promoters,
(4) introducing the fillers, and
(5) mixing the mixture.

The various components of the bituminous mastic according to the invention, in particular the bitumen, the oil, the polymer, the fillers and, if need be, all the optional compounds, are mixed in the proportions defined above.

The introduction of the different optional compounds during step (3) can be carried out simultaneously or by successive additions.

According to a particular embodiment, the optional compounds are introduced in step (2), at the same time as the oil or directly with the bitumen in step (1).

Preferably, steps (1) to (4) are carried out with stirring.

Preferentially, just after step (4) of introducing the fillers, stirring is maintained for no more than 5 minutes, preferably no more than 1 minute, to allow a homogeneous mixture to be obtained.

The mixture obtained at the end of step (4) is then continuously mixed to form a homogeneous mixture, the homogeneity of which is preferably maintained until it is applied. This mixing is preferably carried out at a temperature ranging from 120° C. to 200° C., more preferentially ranging from 130° C. to 190° C., even more preferentially from 140° C. to 180° C. The duration of mixing is from a few seconds to a few minutes, preferably from 0.5 to 4 hours, advantageously from 1.5 to 2.5 hours.

The method as defined above may also comprise, between steps (3) and (4), an additional step (A) of swelling the composition.

Preferably, the optional swelling step (A) is performed at a temperature ranging from 140 to 220° C., more preferentially from 160 to 190.

Preferably, the duration of the swelling step (A) ranges from 10 min to 24 h, preferably from 1 h to 10 h, more preferentially from 2 h to 6 h.

The method as defined above may further comprise, between steps (3) and (4), an additional maturation step (B).

Preferably, the additional step (B) is carried out at a temperature ranging from 100° C. to 220° C., more preferentially from 130° C. to 190° C., even more preferentially from 140° C. to 180° C.

Preferably, the duration of the maturation step (B) ranges from 1 h to 48 h, preferably 5 h to 24 h, more preferentially from 10 h to 20 h, even more preferentially from 15 h to 20 h.

In particular, the method according to the invention may comprise, between steps (3) and (4), both an optional step (A) and an optional step (B).

In this case, steps (A) and (B) can be performed in any order. Preferably, step (A) is performed first and step (B) is performed following step (A).

### Applications of the Bituminous Mastic

The invention also relates to the use of a bituminous mastic as defined above to seal and/or repair cracks present on the surface of building materials.

According to a first alternative, the bituminous mastic according to the invention is used to seal and/or repair discontinuities, notably cracks, present on the surface of a structure, a building or a roadway.

According to a second alternative, the bituminous mastic according to the invention is used to make the junction between two structural elements of a construction.

The invention also relates to the use of a bituminous mastic according to the invention to limit and/or prevent and/or delay the propagation, notably the elongation and/or widening, of discontinuities, notably cracks, present on the surface of a structure, a building or a roadway.

The invention also relates to the use of a bituminous mastic according to the invention to limit and/or prevent and/or delay the penetration and/or infiltration of water inside a structure, a building or a roadway.

The invention also relates to a method for sealing and/or plugging and/or repairing a crack present on the surface of a structure, a building or a roadway comprising applying a bituminous mastic according to the invention at the crack.

This method preferably includes the following steps:
(1′) providing a bituminous mastic as defined above, said bituminous mastic being conditioned at a temperature ranging from 100° C. to 200° C., preferably ranging from 120° C. to 180° C., more preferentially ranging from 130° C. to 160° C.,
(2′) introducing said heated bituminous mastic into the crack, and
(3′) cooling the bituminous mastic.

The introduction of the bituminous mastic into the crack can be carried out according to any conventional crack treatment method. A person skilled in the art knows these different methods and how to adapt them to the crack to be treated in order to guarantee maximum effectiveness.

The invention finally relates to a method for maintaining and/or enhancing the waterproofing of a structure, this method comprising applying a bituminous mastic according to the invention on all or part of the surface of the structure.

This method preferably comprises the following steps:
a) providing a bituminous mastic as defined above, said bituminous mastic being conditioned at a temperature ranging from 100° C. to 200° C., preferably ranging from 120° C. to 180° C., more preferentially ranging from 130° C. to 160° C.,
b) spreading said bituminous mastic over all or part of the surface of the structure, and
c) cooling the bituminous mastic.

The spreading of the bituminous mastic over all or part of the surface of the structure to be treated can be carried out according to any conventional waterproofing coating application method. A person skilled in the art knows these different methods and knows how to adapt them to the structure to be treated in order to guarantee an optimal waterproofing.

The various embodiments, alternatives, preferences and advantages described above for each of the objects of the invention apply to all objects of the invention and may be taken separately or in combination.

The invention is illustrated by the following non-limiting examples.

### EXAMPLES

In these Examples, parts and percentages are by weight unless otherwise stated.

### Material and Methods

The rheological and mechanical characteristics of the bitumen and bituminous compositions referred to in these examples are measured according to the methods indicated in Table 1.

TABLE 1

| | | | Measurement |
|---|---|---|---|
| Property | Abbreviation | Units | standard |
| Needle penetration at 25° C. | P₂₅ | 1/10 mm | EN 1426 |
| Ring-and-ball softening temperature | RBT | ° C. | EN 1427 |
| Dynamic viscosity at 160° C. | V_{dyn} | mPa.s | EN 13702 |
| Resistance to cracking: | Fraass | ° C. | EN 12593 |
| Fraass point of weakness | | | |

Bitumen base: A 160/220 grade bitumen base is selected, with a P25 penetrability of 180 1/10 mm and an RBT of 40.4° C. and available commercially from Total Marketing Services.

Elastomer: The elastomer is a styrene-butadiene-styrene (SBS) block copolymer, comprising 30.5% by weight of styrene and comprising 69.5% by weight of butadiene. The 1,2-vinyl group content is 27.8% by weight based on the total weight of the copolymer. The copolymer has a weight-average molecular mass (Mw) of 142 500 daltons and a polydispersity index PDI of 1.09. The copolymer is commercially available from the company KRATON under the trade name D1192.

Vulcanizing agent: The vulcanizing agent is a sulfur-based agent commercially available from the company TOTAL MARKETING France under the name PAXL.

Hydrogen sulfide scavenger: The hydrogen sulfide (H₂S) scavenger is zinc octoate, commercially available from the company Baerlocher under the trade name Baerostab L 233.

### Hydrocarbon Oils:

Oil H1 is a hydrocarbon oil having:
31% by mass of paraffinic compounds,
49% by mass of naphthenic compounds, and
20% by mass of aromatic compounds.
This oil is available from the company TOTAL MARKETING France.
Oil H2 is a hydrocarbon oil having:
   67% by mass of paraffinic compounds,
   19% by mass of naphthenic compounds, and
   14% by mass of aromatic compounds.

Fillers: The fillers consist of chalk powder with a particle size: 100 microns.

### Method for Preparing Mastic Compositions:

The bitumen base is mixed with the oil in a Silverson® mixing reactor at 140° C. with stirring at 6000 rpm. The elastomer and the vulcanizing agent are added simultaneously to the mixture for 30 min.

Then the reactor is placed in a heating mantle at 180° C. with stirring at 400 rpm for 5.5 h. The temperature is lowered to 160° C. and the stirring is lowered to 200 rpm for 18 h. The hydrogen sulfide scavenger is then added, in succession, to the heated bitumen base while maintaining stirring at 200 rpm. The fillers are then introduced and the mixture is stirred for 45 minutes at a temperature of 180° C.

### Results

### 1. Preparation of the Different Mastic Compositions

The mastic compositions C1 and C2 corresponding to the mixtures detailed in the following Table 2 are prepared according to the protocol described above.

Composition C1 is comparative.

Composition C2 is according to the invention.

TABLE 2

| | | C2 |
|---|---|---|
| | C1 | (according to the |
| Composition | (comparative) | invention) |
| Bitumen base | 35.7% | 35.7% |
| Elastomer | 4.0% | 4.0% |
| Vulcanizing agent | 0.1% | 0.1% |
| H₂S scavenger | 0.2% | 0.2% |
| Oil H1 | 20.0% | — |
| Oil H2 | — | 20.0 |
| Fillers | 40% | 40% |

### 2. Rheological and Mechanical Properties of Compositions C1 and C2

The penetrability at 25° C., the ring-and-ball softening temperature, the dynamic viscosity and the Fraass point of weakness of the above prepared mastic compositions C1 and C2 are measured according to the protocols defined above.

The results of these measurements are given in Table 3 below.

TABLE 3

| | | C2 |
|---|---|---|
| | C1 | (according to the |
| Composition | (cornparative) | invention) |
| P25 (1/10 mm) | 150 | 160 |
| RBT (° C.) | 73.8 | 83.0 |
| V_{dyn} (mPa.s) | 408.8 | 323.1 |
| Fraass (° C.) | −29 | −33 |

Composition C1 according to the invention has, compared with composition C2 according to the prior art:
higher penetrability,
a higher softening temperature,
a reduced viscosity, and
a similar Fraass point of weakness.

The composition according to the invention thus has improved mechanical properties compared with compositions of the prior art while retaining good crack resistance properties.

1-16. (canceled)

17. A bituminous mastic comprising:
from 0.5% to 25% by mass of at least one hydrocarbon oil whose total content of paraffinic compounds, measured according to the ASTM D2140 method, is greater than or equal to 50% by mass, based on the total mass of the oil,
from 15% to 60% by mass of bitumen,
from 20% to 60% by mass of fillers, and
at most 14% by mass of at least one polymer,
based on the total mass of bituminous mastic.

18. The bituminous mastic as claimed in claim 17, wherein the hydrocarbon oil is selected from synthetic oils derived from deasphalting unit fractions (DAO) and mixtures thereof.

19. The bituminous mastic as claimed in claim 17, wherein the hydrocarbon oil has a content of naphthenic compounds, measured according to the ASTM D2140 standard, of less than or equal to 25% by mass. based on the total mass of hydrocarbon oil.

20. The bituminous mastic as claimed in claim 19, wherein the hydrocarbon oil has a content of naphthenic compounds, measured according to the ASTM D2140 standard ranging from 5% to 25% by mass, based on the total mass of hydrocarbon oil.

21. The bituminous mastic as claimed in claim 17, wherein the hydrocarbon oil has a content of paraffinic compounds, measured according to the ASTM D2140 standard, greater than or equal to 50% by mass, based on the mass of hydrocarbon oil.

22. The bituminous mastic as claimed in claim 17, wherein the hydrocarbon oil has an aniline point, determined according to the ISO 2977:1997 standard, greater than or equal to 80° C.

23. The bituminous mastic as claimed in claim 17, wherein the polymer is selected from elastomers.

24. The bituminous mastic as claimed in claim 17, wherein the polymer is selected from block copolymers.

25. The bituminous mastic as claimed in claim 24, wherein the polymer is selected from block copolymers based on conjugated diene units and monovinyl aromatic hydrocarbon units.

26. The bituminous mastic as claimed in claim 25, wherein the polymer is selected from block copolymers based on butadiene units and styrene units.

27. The bituminous mastic as claimed in claim 26, wherein the polymer is selected from styrene-butadiene block copolymers having a weight content of 1,2-vinyl groups ranging from 10% to 70%, based on the total mass of the copolymer.

28. The bituminous mastic as claimed in claim 27, wherein the block copolymer based on styrene and butadiene has a mass-average molecular mass ranging from 10 000 to 500 000 g·mol⁻¹.

29. A method for preparing a bituminous mastic as claimed in claim 17, comprising at least the following steps:
(1) heating the bitumen to a temperature ranging from 100° C. to 220° C.,
(2) introducing the hydrocarbon oil with stirring,
(3) optionally adding the polymer,
(4) introducing the fillers, and
(5) mixing the mixture.

30. A method for sealing and/or repairing cracks present on the surface of a building material, and/or for maintaining and/or enhancing the waterproofing of a structure, the method comprising the application of a bituminous mastic as claimed in claim 17 to the surface of a building material.

31. The method as claimed in claim 30, wherein the cracks are present on the surface of a structure, a building or a roadway.

32. The method as claimed in claim 30 wherein the bituminous mastic is applied as a joint between two structural elements of a construction.

33. The method as claimed in claim 30 to limit and/or prevent and/or delay the propagation, present on the surface of a structure, a building or a roadway.

34. The method as claimed in claim 30 to limit and/or prevent and/or delay the penetration and/or introduction of water into the interior of a structure, a building or a roadway.

35. The method as claimed in claim 30, this method comprising:
(1) providing a bituminous mastic comprising:
from 0.5% to 25% by mass of at least one hydrocarbon oil whose total content of paraffinic compounds, measured according to the ASTM D2140 method, is greater than or equal to 50% by mass, based on the total mass of the oil,
from 15% to 60% by mass of bitumen,
from 20% to 60% by mass of fillers, and
at most 14% by mass of at least one polymer,
based on the total mass of bituminous mastic,
the bituminous mastic being conditioned at a temperature ranging from 100° C. to 200° C.,
(2) introducing the heated bituminous mastic into the crack, and
(3) cooling the bituminous mastic.

36. The method as claimed in claim 30, for maintaining and/or enhancing the waterproofing of a structure, this method comprising:
(1) providing a bituminous mastic comprising:
from 0.5% to 25% by mass of at least one hydrocarbon oil whose total content of paraffinic compounds, measured according to the ASTM D2140 method, is greater than or equal to 50% by mass, based on the total mass of the oil,
from 15% to 60% by mass of bitumen,
from 20% to 60% by mass of fillers, and
at most 14% by mass of at least one polymer,
based on the total mass of bituminous mastic,
the bituminous mastic being conditioned at a temperature ranging from 100° C. to 200° C.,
(2) spreading the bituminous mastic over all or part of the surface of the structure, and
(3) cooling the bituminous mastic.
